(19) United States
(12) Patent Application Publication
(10) Pub. No.: US 2014/0255263 A1
(43) Pub. Date: Sep. 11, 2014

(54) APPARATUS FOR THE LIQUID-PHASE SYNTHESIS OF ISOPRENE FROM ISOBUTYLENE AND FORMALDEHYDE

(71) Applicants: Arkadii Samuilovich Dykman, Sankt-Peterburg (RU); Gamil Gabdrahmanovich Sibagatullin, Nizhnekamsk (RU); Elena Vladimirovna Fedorcova, Sankt-Peterburg (RU); Aleksei Michailovich Flegontov, Sankt-Peterburg (RU)

(72) Inventors: Arkadii Samuilovich Dykman, Sankt-Peterburg (RU); Gamil Gabdrahmanovich Sibagatullin, Nizhnekamsk (RU); Elena Vladimirovna Fedorcova, Sankt-Peterburg (RU); Aleksei Michailovich Flegontov, Sankt-Peterburg (RU)

(73) Assignee: Obshestvo s Ogranichennoi Otvetstvennostiu "NAUCHNO-PROIZVODSTVENNOE OBEDINENIE EUROCHIM", Sankt-Peterburg (RU)

(21) Appl. No.: 14/239,243

(22) PCT Filed: Nov. 22, 2011
(86) PCT No.: PCT/RU2011/000916

§ 371 Date: Apr. 15, 2014

(30) Foreign Application Priority Data
Aug. 17, 2011 (RU) 2011122950

(51) Int. Cl. B01J 8/06

(52) U.S. Cl. CPC B01J 8/06
USPC 422/187

(57) ABSTRACT

The apparatus for liquid-phase synthesis of isoprene from isobutylene and formaldehyde, comprising the following units of synthesis of isoprene precursors: 1,3-dioxanes synthesis unit; unit for TMC synthesis from isobutylene-containing fraction; unit for TMC synthesis from recycled concentrated isobutylene derived either from isoprene synthesis unit or from the unit for synthesis products separation and isoprene monomer isolation; isoprene synthesis unit; by-products decomposition unit; unit for synthesis products separation and isoprene monomer isolation. The apparatus is characterized with separation of by-product fractions from 1,3-dioxanes synthesis unit; with assignment of light fraction for sale or its supply for combined decomposition with the by-products (MDHP fraction), formed during separation of synthesis products and isolation of isoprene monomer; with assignment of heavy fraction for sale, at that TMC and 1,3-dioxanes that were formed in the corresponding units are simultaneously supplied for combined decomposition to isoprene synthesis unit while the unit for separation of synthesis products and isolation of isoprene monomer is directly connected with isoprene synthesis unit, by-products decomposition unit as well as with the unit for TMC synthesis from recycled concentrated isobutylene. The apparatus is also characterized by the following: 1,3-dioxanes synthesis unit includes by-products separation into light, medium and heavy fractions, from which the light fraction of by-products is fed for homogenous decomposition to isoprene synthesis unit and/or to by-products decomposition unit for combined decomposition with the by-products (MDHP fraction) formed during separation of synthesis products and isolation of isoprene monomer; the medium fraction of by-products is assigned for sale and/or mixed with the light fraction of by-products and supplied to by-products decomposition unit; and unreacted isobutylene from the unit of TMC synthesis from recycled concentrated isobutylene is supplied to the unit of TMC synthesis from isobutylene-containing fraction, being previously mixed.

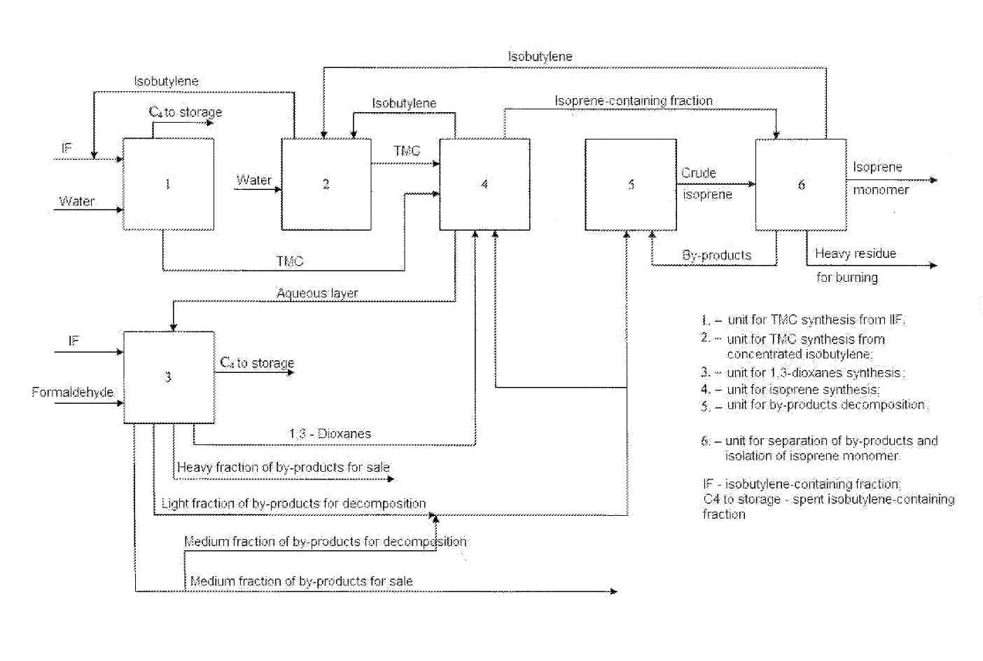

Present useful model relates to apparatus used in production of monomers for synthetic rubber manufacturing, and, in particular, to layout and interconnection of the units for liquid-phase synthesis of isoprene from isobutylene and formaldehyde or from sources of isobutylene and formaldehyde, such as trimethyl carbinol (TMC) or dimethyl dioxane (DMD) in presence of aqueous solution of acid catalyst.

There is a known design of the reactor unit that includes two sequentially connected devices—airlift column and shell-and-tube column with external circulation system that connects upper separation zone and bottom reaction zone, equipped with distribution devices in the lower part of the columns and supplied with ring-shaped narrowings installed on the inside surface of the reactor tubes at the same height, said devices are meant to increase actual residence time of the reagents in the reaction volume [Patent RU 2096076, 1994]. This design is able to partially eliminate common disadvantage of tube reactors, i.e. abrupt change of gas phase to liquid phase ratio by the height of the tube. The achieved effect is based on the fact that density of mixture flow slightly increases at tube sections located above the narrowing. Nevertheless, installation of the narrowings can not eliminate other disadvantages of said design, such as considerable specific consumption of metal, complexity of process management, unavoidable isoprene loss due to its ineffective isolation from the reaction medium and so on.

There is a known design of liquid-phase one-stage isoprene synthesis apparatus, which comprises vertically installed hollow reactor connected within one unit with shell-and-tube heat exchanger of parallel or coaxial layout , meant for heating reaction mass and processing part of feedstock.

Steam is supplied to shell side of the heat exchanger and the reaction mass is circulating through the tubes. At the bottom of cylinder part of the reactor, in line with axis of the tube connecting reactor with upper part of heat-exchanger, distribution device is installed, meant for introduction of the main part of feedstock.

Distribution device of analogous design is installed in the bottom part of the heat exchanger (under the tube sheet) in line with the axis of the tube connecting said device with the reactor (over the upper tube sheet). The second tube, connecting reactor with bottom zone of the heat exchanger, located below tube sheet, offtakes from the lowest point of spherical part of the reactor. Tube for contact gas outlet to separator offtakes from the highest point of the reactor (Patent RU 32706, 2003). This design ensures thorough mixing of the reaction mass and also, as importantly, effective offtake of mixed isoprene-isobutylene flow from reaction zone.

However, principal disadvantage of said design is presence of external heat exchanger, which leads to increase in specific consumption of metal in the apparatus design (due to production of heavy flanges and shell of the shell-and-tube reactor) and, most importantly, is associated with inevitable heat losses. Because of aforementioned heat losses feedstock must be preliminary heated up to the reaction temperature or overheated 5-7° C. above that temperature. Considering that feedstock is supplied into the reactor together with aqueous solution of acid catalyst, this procedure inevitably leads to feedstock loss on formation of additional quantities of by-products and creates conditions for tar formation.

There is a known simplified design of apparatus for the liquid-phase synthesis of isoprene from isobutylene and formaldehyde which allows to conduct synthesis in one reaction zone (one stage),comprising vertical hollow reactor, with built-in shell-and-tube heat exchanger meant for provision of heat needed for carrying out the reaction, and one or two circulation pipelines connecting upper and bottom part of reactor, diameter of said pipelines exceeds diameter of heat exchanger tubes minimum in 5 times. The shell of hollow reactor is also a shell of heat-exchanger. The volume ratio of upper and bottom part of the hollow reactor, separated by built-in heat exchanger, equals to the value of at least 2-2.5. Circulation of reaction mass is conducted inside the heat exchanger tubes due to density difference of gas and liquid. For intensification of mixing induced circulation through the use of pump can be applied. Both parts of the reactor contain distribution devices meant for feedstock inlet.

Distribution devices constitute a network of tubes with the orifices of 2-5 mm diameter, installed in parallel on a central (feeding) pipeline. Area of the distribution devices, calculated based on their overall dimensions, amounts to 25% max. of the vessels' cross section wherein these devices are installed. (Patent RU 42185, 2004).

The advantage of offered apparatus consists in reduction of specific consumption of metal in the design of reactor unit due to structure simplification, i.e. exclusion of flange connections and employment of the reactor shell as heat-exchanger shell. Nevertheless, in a short run an additional amount of by-products forms in the apparatus that increases tar formation and results in feedstock losses.

There is a known apparatus for liquid phase synthesis of isoprene from isobutylene and formaldehyde with homogeneous acid catalyst present, which is not equipped with rectification units for intermediate synthesis products (U.S. Pat. No. 4,511,751, 1985; U.S. Pat. No. 4,593,145, 1986). The apparatus comprises 2-4 reactors connected in succession, meant for interaction of acidic aqueous solution of formaldehyde with isobutylene and/or trimethyl carbinol at a temperature of 150-220° C. and under a pressure in 1 to 2.5 times higher than pressure of the reaction mixture vapors at the same temperatures. Isobutylene and/or trimethyl carbinol are fed only into the first reactor and formalin is fed into each reactor. Isoprene, water, unreacted feedstock are let out from each reaction zone and introduced to the next one with further outlet from the last reaction zone. Yield of isoprene from the converted formaldehyde and isobutylene is insufficient and amounts to 52 and 74%, respectively.

The apparatus for liquid phase synthesis of isoprene from isobutylene and formaldehyde is also known (Patent RU 2280022, 2006). The apparatus consists of several connected reactors (units) for synthesizing of isoprene precursors and decomposition unit of formed products. One or two rectification columns are installed in between synthesis units and decomposition unit. The apparatus includes separation unit for the products formed in decomposition reactor.

Formation of significant amount of high-boiling by-products and their accumulation in the system, leading to formation of inseparable into layers emulsions and solid deposits causing equipment clogging, in particular, at the industrial application, disadvantage the said apparatus operation. It results from penetration of high-boiling by-products (HBBP), specially, theirs heavy fraction, i.e. formals of dioxane alcohols, formed during synthesis of isoprene precursors, in particular, DMD, to decomposition unit that operates under the conditions of high temperatures (130-170° C.) and high concentration of acid catalyst. HBBP, i.e. dioxane alcohols mixed with their derivatives, convert into green oil, which can be used only as low-grade fuel while HBBP find a wide application in the national economy and their value is significantly higher than feedstock cost. HBBP conversion into such a by-product, as green oil, dramatically boosts net cost of the process. Moreover, light fraction of HBBP together with pyranes fraction can be decomposed into initial feedstock and isoprene.

This apparatus doesn't allow for heterogeneous catalytic decomposition of pyranes fraction that also degrades technical and economical metrics of the process. The mixture of TMC and isobutylene used as isobutylene source in isoprene synthesis unit also worsens selectivity of the process and affects consumption rates.

The most approximated to offered useful model in terms of technical concept is the apparatus for the liquid-phase synthesis of isoprene from isobutylene and formaldehyde (Patent RU 72972, 2008-prototype). The apparatus consists of DMD synthesis unit isolated from two units of TMC synthesis operating in parallel (i.e. the unit for synthesizing from isobutane-isobutylene fraction (IIF) and the unit for synthesizing from recycled concentrated isobutylene derived from isoprene synthesis unit and synthesis product separation and isoprene monomer isolation unit). TMC and DMD produced in the said units are simultaneously fed to isoprene synthesis unit for combined decomposition. Rectification unit is installed downstream of DMD synthesis unit where high-boiling by-products form. Light fraction of by-products, rectified in this unit, is assigned either for sale, or for combined decomposition with by-products (fraction of 4-methyl-5,6-dihydro-pyrane (MDHP)) obtained during separation of synthesis products and isolation of isoprene monomer, or assigned both for sale and decomposition. Heavy fraction is assigned for sale. The unit of synthesis product separation and isoprene monomer isolation is directly connected with isoprene synthesis unit, by-products decomposition unit and DMD synthesis unit.

The apparatus based on prototype doesn't allow for reduction of net cost and consumption rates of the process.

In order to decrease net cost of isoprene and improve technical and economical metrics of the process of liquid-phase synthesis of isoprene from isobutylene and formaldehyde, the apparatus was offered which flow diagram is presented in the Figure hereto.

The apparatus consists of the unit 1 for TMC synthesis from IIF, operating in parallel with the unit 2 for TMC synthesis from recycled concentrated isobutylene and the unit 3 for 1,3-dioxanes synthesis which is isolated from TMC synthesis units and equipped with rectification unit for by-products formed in it. There are the following units in downstream succession: the unit 4 for isoprene synthesis, the unit 5 for by-products decomposition and the unit 6 for by-products separation and isoprene monomer isolation. The units 4 and 5 are directly connected with the unit 6.

The apparatus operates in the following way:

IIF and water are fed to the unit 1. TMC is produced in the zone reactors filled in with cationite. Spent C4 fraction is directed from the unit 1 to storage and TMC derived from separation from recycled C4 fraction is supplied to the unit 4 for isoprene synthesis, which is simultaneously fed with 1,3-dioxanes from the unit 3. The required amount of 1,3-dioxanes is synthesized in the unit 3, for which purpose the unit 3 is fed with IIF, formaldehyde and aqueous layer from the unit 4. Spent C4 fraction is directed from the unit 3 to storage

Isoprene-containing fraction, produced in the unit 4, is supplied to the unit 6 for separation of synthesis products and isolation of isoprene monomer, and concentrated isobutylene, separated in the unit 4 and the unit 6, is recycled to the unit 2 for TMC synthesis from concentrated isobutylene. The unit 2 is simultaneously fed with water. Unreacted isobutylene from the unit 2 for TMC synthesis from concentrated recycled isobutylene is supplied to the unit 1 for TMC synthesis from isobutylene-containing fraction, being previously mixed.

High-boiling by-products that are formed during 1,3-dioxanes synthesis in the unit 3, are separated into light, medium and heavy fractions.

The heavy fraction of by-products is assigned for sale.

The light fraction is either assigned for sale or directed to the unit 4 or 5 or both units simultaneously. The medium fraction of by-products is either assigned for sale or mixed with light fraction of by-products and the resulting mixture is fed to the unit 5 for by-products decomposition.

At the same time the by-products (MDHP fraction) of isoprene synthesis are fed from the unit 6 to the unit 5. Isoprene-containing fraction from the unit 5 is directed for separation of synthesis products and isolation of isoprene monomer to the unit 6, in which isolation of commercial-grade isoprene rectificate and by-products separation are conducted.

The distinctive features of the offered apparatus versus the prototype are:
feed of the unreacted isobutylene from the unit 2 to the unit 1 simultaneously with initial isobutylene-containing fraction;
separation of by-products of 1,3-dioxanes synthesis derived from the unit 3 into three fractions: light, medium, and heavy fractions, from which the light fraction of by-products is supplied to the unit 4, otherwise mixing of light fraction with medium one and supply of the combined flow to the unit 5 for by-products decomposition.

Recycled unreacted isobutylene from the unit 2 for TMC synthesis from concentrated isobutylene supplied to the unit 1 for TMC synthesis from IIF allows thanks to isobutylene concentration increase to improve conversion by 1.5% in the unit 1 for TMC synthesis from IIF, which, as a consequence, increases the overall productivity of the apparatus by 2%; the improvement also allows for maintaining of high concentration of isobutylene in the unit 2 for TMC synthesis from concentrated isobutylene due to outlet of isobutane together with isobutylene as well as to increase isobutylene conversion.

Introduction of light fraction to isoprene synthesis unit allows for saving heat energy as the dilution with steam is unnecessary in such a situation.

Industrial employment of the offered apparatus allows for reduction of specific consumption of isobutylene by 2 kg per ton, formaldehyde by 3 kg per ton, heat energy by 0.2 GCal per ton of isoprene. The assignment for sale of medium fraction of HBBP calculated based on the ratio of 34 kg per 1 ton of isoprene (formed in 1,3-dioxanes synthesis unit) allows for reduction of net cost of the target product by 1.1%.

What is claimed is:

1. The apparatus for liquid-phase synthesis of isoprene from isobutylene and formaldehyde, comprising the units for synthesizing products of isoprene precursors, namely 1,3-dioxanes, trimethyl carbinol derived from isobutylene-containing fraction, trimethyl carbinol derived from recycled concentrated isobutylene isolated both from isoprene synthesis unit and from the unit for synthesis product separation and isoprene monomer isolation, isoprene synthesis unit, by-product decomposition unit, unit for synthesis product separation and isoprene monomer isolation, with separation of by-product fractions from 1,3-dioxane synthesis unit, with assignment of the separated light fraction for sale, or for combined decomposition with by-products (methyldihydropyrane fraction), formed during synthesis product separation and isoprene monomer isolation, and assignment of the separated heavy fraction for sale, with that trimethyl carbinol and 1,3-dioxanes which were formed in the indicated units are simultaneously supplied for combined decomposition to isoprene synthesis unit, while the unit for synthesis product separation and isoprene monomer isolation is directly connected with isoprene synthesis unit, with by-product decomposition unit as well as with the unit for trimethyl carbinol synthesis from recycled concentrated isobutylene, is characterized by 1,3-dioxane synthesis unit that includes by-products separation into light, medium and heavy fractions, from which the light fraction of by-products is supplied for homogeneous decomposition to isoprene synthesis unit and/or to by-product decomposition unit for combined decomposition with by-products (methyldihydropyrane fraction) formed during synthesis product separation and isoprene monomer isolation, the medium fraction of by-products is assigned for sale and/or mixed with the light fraction of by-products and sent to by-product decomposition unit, and unreacted isobutylene from the unit of trimethyl carbinol synthesis from recycled concentrated isobutylene is fed into the unit of trimethyl carbinol synthesis from isobutylene-containing fraction and is mixed with said fraction beforehand.
